(19) United States
(12) Patent Application Publication
(10) Pub. No.: US 2020/0287710 A1
(43) Pub. Date: Sep. 10, 2020

(54) SINGLE STREAM ONE TIME PAD WITH ENCRYPTION WITH EXPANDED ENTROPY

(71) Applicant: Introspective Power, Inc., Broomfield, CO (US)

(72) Inventor: Anthony Scott THOMPSON, Broomfield, CO (US)

(21) Appl. No.: 16/809,237

(22) Filed: Mar. 4, 2020

Related U.S. Application Data
(60) Provisional application No. 62/813,741, filed on Mar. 4, 2019.

(51) Int. Cl. H04L 9/06; G06F 7/58; H04L 9/32; H04L 29/06

(52) U.S. Cl. CPC H04L 9/0656; H04L 63/18; H04L 9/3215; G06F 7/588

(57) ABSTRACT

A system gets entropy from one side of a communications channel to the other by using methods to deterministically change the expansion array. This can be encrypted with anything as the payload. The messages for expansion are encrypted with a one-time-pad (OTP) so they cannot be discovered. A purpose is to use OTP encryption to distribute entropy to two or more sides of a communications channel from a third server that delivers TRNG (True Random Number Generation).

### CROSS REFERENCES TO RELATED APPLICATIONS

This application claims priority from U.S. Provisional Application No. 62/813,741 filed Mar. 4, 2019, incorporated herein by reference.

### STATEMENT REGARDING FEDERALLY SPONSORED RESEARCH OR DEVELOPMENT

None.

### FIELD

The technology herein relates to computer security, and more particularly to systems and methods for transporting entropy from one side of a messaging system to another side of the messaging system. The technology herein also relates to systems and methods for deterministically changing entropy expansion arrays.

### BACKGROUND & SUMMARY

Entropy measures the amount of disorder or randomness. Randomness in a computer system is often a bad thing, since we usually expect computer results to be deterministic i.e., given the same inputs, the computer should generate the same outputs. However, entropy and randomness play important roles in secure computer messaging where unpredictability can be an advantage.

When you access your bank account online, you probably do not want anyone else to listen in to the digital conversion between your computer or smart device and the bank's computer system. To protect the exchange of banking information, your computer/smart device and the bank's computer each transform the exchanged information into a different (unreadable) form before sending it over a public network or communications channel such as the Internet or a cellular telephone network, point-to-point wireless communication, etc. The different form conceals the “clear text” content of the information from digital eavesdroppers. On the other side, your computer/smart device or the bank's computer transforms the unreadable form back into its original clear text form so it can be used. To secure the information exchange, the transformation is designed so it is computationally infeasible for an eavesdropper to learn or derive the clear text from the unreadable form.

To accomplish this goal, the transformation used to convert the clear text into the unreadable form (sometimes called “cipher text”) should be unpredictable. If the transformation is predictable, then an eavesdropper will be able to guess it and derive the clear text.

As a simple example, suppose Bob wants to send a secret message “meet at ten P” to Alice. Bob decides to use a transform that equates each letter with a number corresponding to the position of the letter in the alphabet, adds the two numbers together, and looks up the alphabet letter corresponding to sum. If the sum exceeds 26, Bob subtracts 26 and uses the result to look up the corresponding letter. Bob decides to use Alice's name as the “key” to transform the clear text into cipher text. This is what the transformation looks like using the key “ALICEALICE”:

| | | | | | | | | | |
|---|---|---|---|---|---|---|---|---|---|
| M | E | E | T | A | T | T | E | N | P |
| A | L | I | C | E | A | L | I | C | E |
| N | Q | N | W | F | U | F | N | Q | U |

The resulting cipher text “NQNWFUFNQU” appears to be unintelligible and therefore secure. However, if Deborah knows that Bob is sending the message to Alice, it would not be surprising for Deborah to guess that Bob has used Alice's name as the “key” for the transformation. Once Deborah guesses the correct key, it is a simple matter for her to try different transformations until she gets intelligible results. Deborah's computer could crack the above code in just a few seconds, revealing the clear text message.

To avoid the attack, Bob could instead choose a key that is truly random and thus unpredictable. If each element of the random key is used only once (i.e., to transform a single letter of the clear text message before being discarded), the system will be perfectly secure.

While the above approach seems to be straightforward, it should be apparent that both Bob and Alice need the same “key” in order to make the system work. A challenge is to distribute the random key (which may be a stream of numbers or other values) so it is available to both Bob and Alice but not to Deborah. Bob could share the secret key with Alice when they meet in person, but this is inconvenient in the modern electronic, network-connected world. Further improvements are therefore possible and desirable.

### BRIEF DESCRIPTION OF THE DRAWINGS

Please refer to the following detailed description of example non-limiting embodiments in conjunction with the drawings, of which:

FIG. 1 is a block diagram of an example system.

FIG. 1A shows an example non-limiting station architecture.

FIG. 1B shows an example encryption process.

FIG. 1C shows an example decryption process.

FIG. 2 shows an example entropy expansion.

FIG. 3 shows an example non-limiting entropy expansion using looping.

FIG. 4 shows an example non-limiting entropy expansion using SIMD.

FIG. 5 shows an example non-limiting single stream OTP encryption using repeat size bound.

FIG. 6 shows an example single stream OTP encryption using size messaging.

FIG. 7 shows an example single stream OTP encryption using an alternating token based organization.

FIG. 8 shows an example single stream OTP encryption using tokens with type.

FIG. 9 shows an embodiment where the random data is on one communications channel and encrypted ciphertext is on another.

### DETAILED DESCRIPTION OF EXAMPLE NON-LIMITING EMBODIMENTS

Example non-limiting embodiments herein get the entropy from one side to the other along with methods to deterministically change an expansion array used to produce an entropy expansion. This can be encrypted with anything as the payload is a one time pad (OTP).

In some example embodiments, the messages for expansion are encrypted with an OTP so they cannot be discovered. A non-limiting purpose of this incarnation is to distribute entropy to two or more sides from a third server that delivers TRNG (True Random Number Generation). This new incarnation is OTP encrypted. Its primary payload is data with a to-be-expanded OTP included in the stream. This allows for both data and TRNG to be delivered in a single stream. This would still be a special case as some specific embodiments would not necessarily be good for audio/video (A/V) use because of the interruption caused by processing the entropy payload but might have a purpose where resources are tight and a TRNG can be available in the hardware (think Smart Home device).

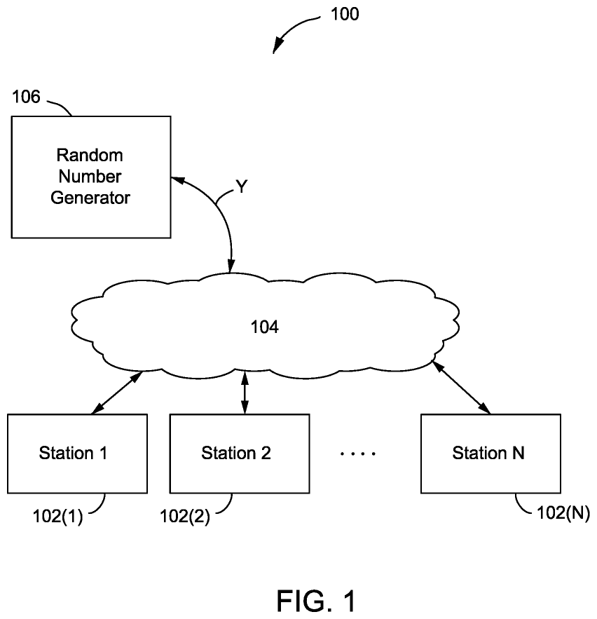

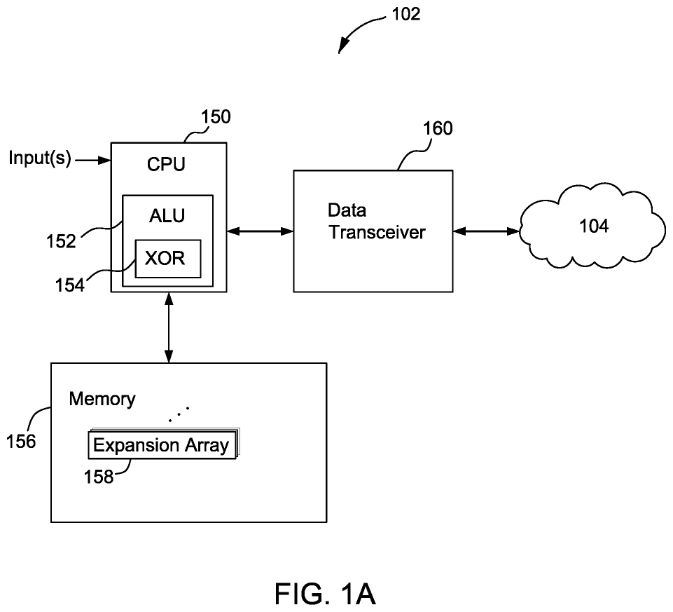

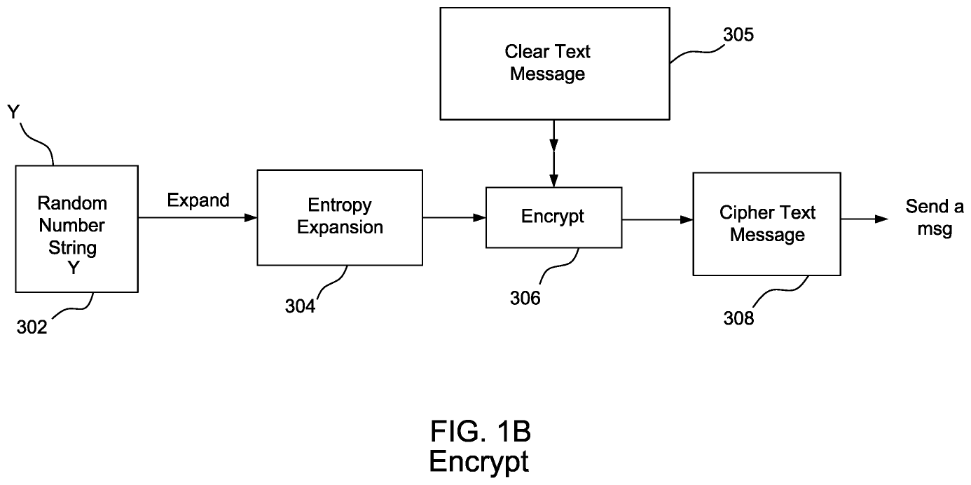

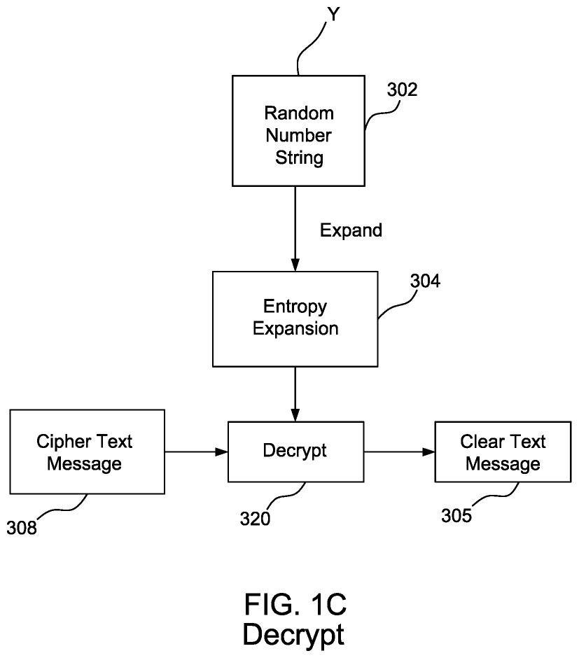

FIG. 1 shows an overall example non-limiting system including a TRNG 106 located in the cloud and connected by one or more networks 104 to one or more stations 102. The stations 102 communicate amongst themselves using secure communications protocols based on OTPs generated or otherwise supplied by the TRNG 106. Communications between the TRNG 106 and the stations 102 and between the stations can be performed in any convenient way including wired, wireless, via the Internet, via a cellular telephone network, via point-to-point communications, etc.

FIG. 1A shows an example non-limiting station 102 architecture including a CPU 150, a memory 156, and a data transceiver 160. The CPU 150 includes an arithmetic logic unit (ALU) 152 or other hardware or software arrangements such as calculation circuitry or instructions capable of executing an exclusive-OR operation 154. The CPU 150 is coupled to a memory 156 that stores an expansion array 158. Memory 156 is a non-transitory storage device that also stores instructions that CPU 150 executes. The CPU 150 communicates with network 104 via the data transceiver 160.

FIG. 1B shows an example encryption process that station 102 may perform. A random number string Y 302 supplied by TRNG 106 may be expanded to provide expanded entropy 304 that in turn is used by encrypt block 306 to encrypt a clear text message 305 to provide a ciphertext message 308 for storage and/or transmission.

FIG. 1C shows an example decryption process that the same or different station 102 may perform to transform the ciphertext message 308 back into the clear text message 305 using a decrypt block 320 that uses expanded entropy 304 derived from the TRNG 106. If the entropy expansion at the FIG. 1C decryption station matches the entropy expansion at the FIG. 1B encryption station, the decryption station can perform an exact inverse transformation of the transformation the FIG. 1C encryption station performs to recover the original clear text. XOR for example has the property where a second application of the same value to an original XOR result yields the starting operand. However, other embodiments use different transformations at the encryption station and decryption station to allow the decryption station to recover the original clear text from the ciphertext the encryption station outputs. Such operations use the entropy expansion as a secret that is shared between the encryption station(s) and decryption station(s). As long as the shared information remains secret, the communications system will remain secure.

There can be any number of encryption stations 1B and any number of decryption stations 1C. In one example embodiment, one encryption station communicates with one decryption station. In another example embodiment, one encryption station communicates with plural (N, where N is any number) decryption stations. In a further example embodiment, plural (M, where M is any number) encryption stations communicate with one decryption station. In another example embodiment, N encryption stations communicate with M decryption stations.

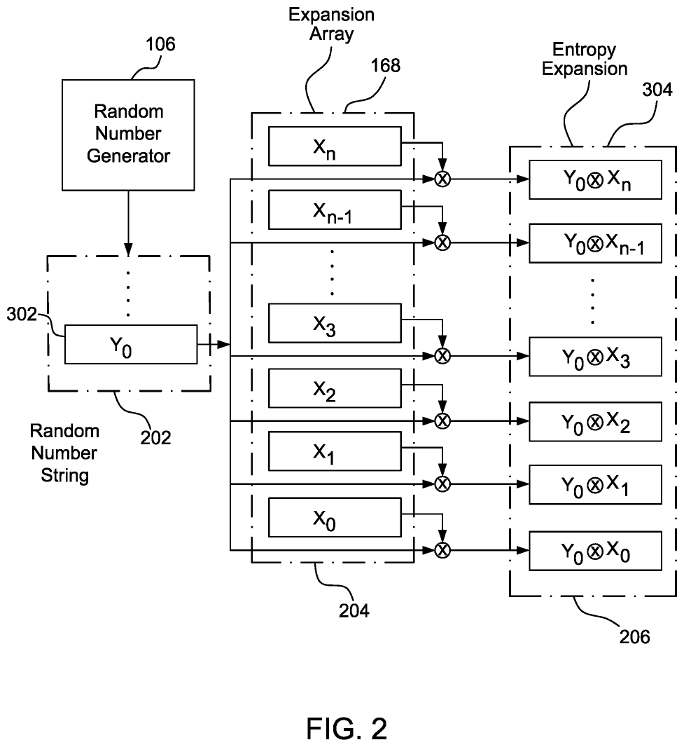

FIG. 2 shows an example expansion of a random number string 202 (Y) provided by the TRNG 106 into expanded entropy 304. The TRNG 106 can be co-located with or located remotely from the encryptor 306. The example shown uses an exclusive-OR (XOR) operation to XOR an element of the random number string 202 produced by TRNG 106 with each element of an expansion array 158 (X0, X1, X2, . . . XN). In one example embodiment, the expansion array 158 may be provided to one or more stations 102 in advance and prestored in their associated memories 156. There can be more than one expansion array 158 so the same entropy provided by random number string 202 can be expanded into many different expanded entropy strings. So long as each expansion array 158 is truly random and kept secret along with the random number string 202, the resulting expanded entropy 304 will also be equivalent to true random—there is no way to guess the values of the resulting expansion. Moreover, the expanded results can be expanded N number of times against N number of expansion arrays one element at a time.

In some embodiments, the expansion arrays can be of fixed sizes or varying sizes. This will create even more entropy and further obfuscate the final random results. This may be very useful if your data is critical and of high value.

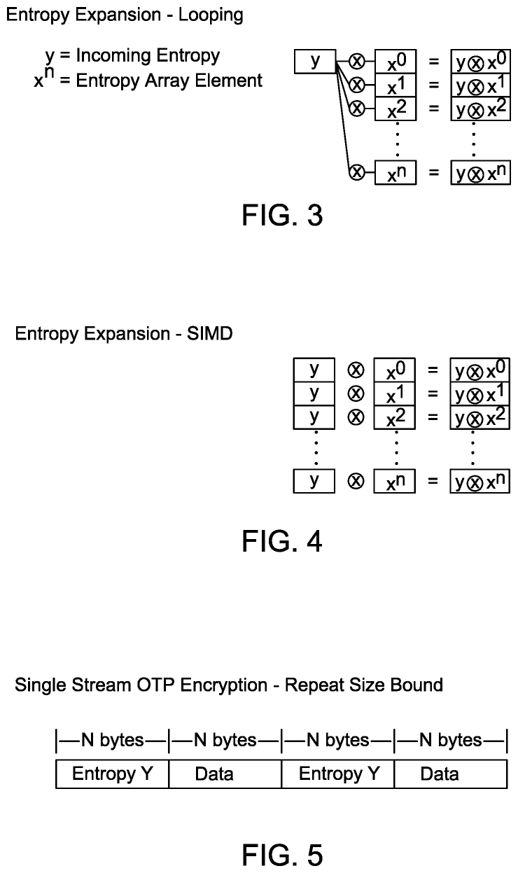

FIG. 3 shows an example entropy expansion using looping. The elements of the entropy expansion 304 are calculated one at a time in seriatim by a pipelined processor or processing circuit to provide a sequence of entropy expansion values.

FIG. 4 shows an example entropy expansion using SIMD type parallel processing. The elements of the entropy expansion 304 may be calculated concurrently in parallel using parallel processing.

Once the procedures above are provided to generate entropy expansion 304, an originating station may use the expanded entropy as a one time pad (OTP) to encrypt a message such as a data stream which the station can then send over the network 104. In some embodiments, the originating station 102 may, within this same transmission, send parts of the entropy expansion it will use in the future to encrypt later parts of the data stream. The receiving station can receive, cache and expand this entropy expansion for later use in decrypting (or encrypting) a further portion(s) of the encrypted stream. It can also expand the entropy in near real time holding a cache of potential entropy size without actually requiring the storage for that full potential size. This is a useful feature for smaller devices like sensors that may have small storage capacity.

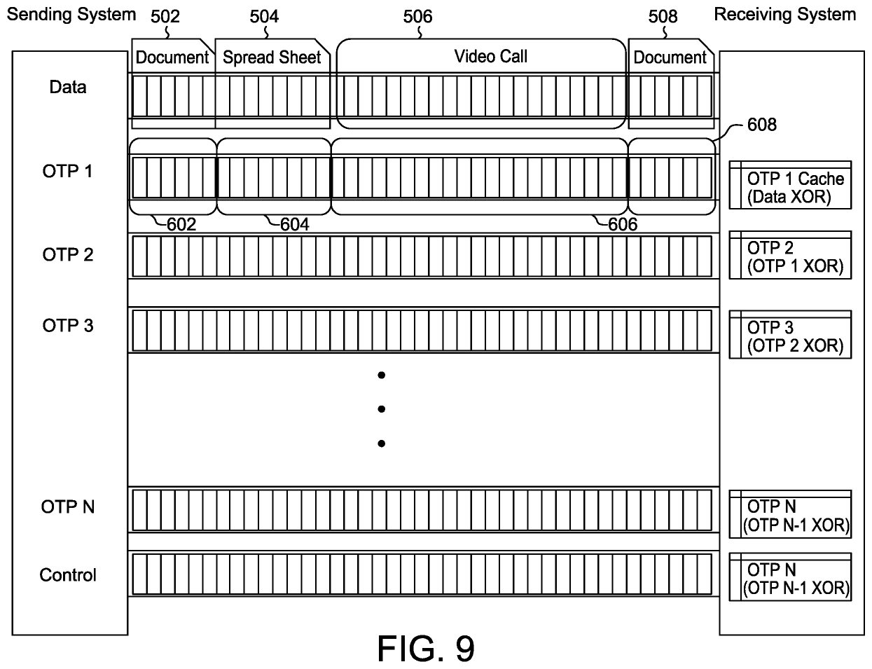

In example non-limiting preferred embodiments, a mixed stream of encrypted data and entropy can be sent over the same channel using port facading and/or port rotation, to allow both encrypted data and future entropy to be conveyed over a single channel See FIG. 9, which shows how such a multichannel communications system can be used to transport encrypted information of various types. The entropy sent over the channel can be not-yet-expanded to provide a compact representation for transmission. The receiving station 102 can expand the entropy prior to use to provide a much longer OTP for use in decrypting and/or encrypting.

For example, FIG. 5 shows a single stream OTP encryption using a repeat size bound. The stream is segmented into alternating portions, with N bytes of entropy followed by N bytes of data followed by N bytes of entropy followed by N bytes of data and so on.

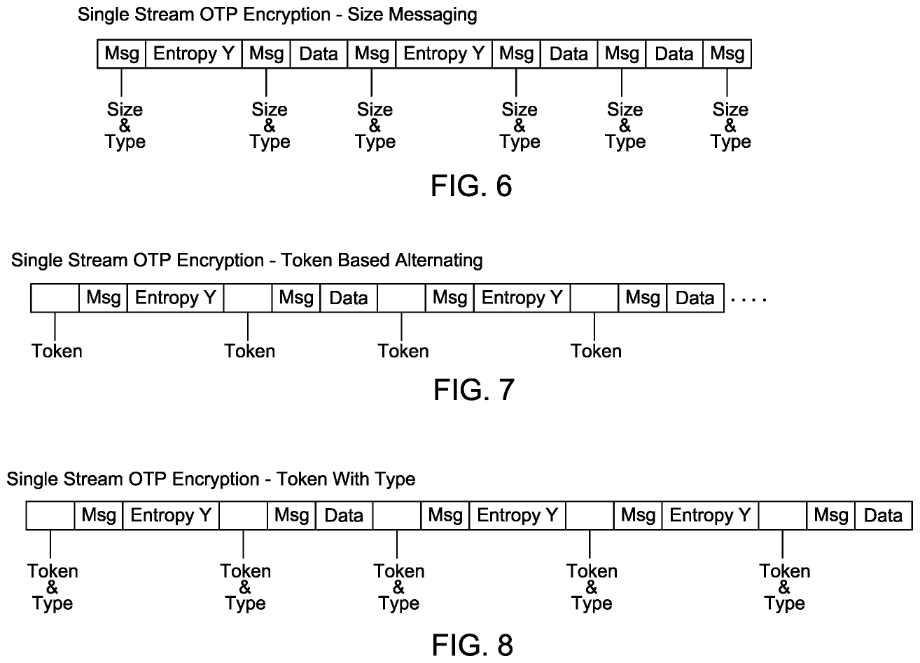

FIG. 6 shows another embodiment in which each segment in the stream is preceded with a size/type header or marker that indicates whether the immediately following stream segment is entropy or encrypted data, and also indicates the length of the following segment. This arrangement allows any sequence of entropy and data, and different segments can have different lengths.

FIG. 7 shows a token based approach in which tokens are embedded within the stream to separate entropy from data, the entropy alternating with the data.

FIG. 8 shows a token type approach, in which the token specifies the type of segment (entropy or data) that immediately follows the token. Such an approach allows any length of segment and any order of segments.

FIG. 9 shows an embodiment where the random data is on one communications channel and the encrypted ciphertext is on another. In this figure, we also disclose using one encryption channel to encrypt another. This increases the number of channels involved which further obfuscates the information in the network.

In some example embodiments, the system can be “primed” with a certain amount of shared entropy. This can be shared over a legacy encrypted stream, emailed, provided via a QR Code, or in other ways. This “primed” shared entropy can then be used as the basis for encrypting further entropy exchanged over a communications channel, and expanded as needed to encrypt further data.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A secure communication system comprising:
a random number generator configured to generate a random number string;
a processor or processing circuit that expands the random number string to generate entropy expansion; and
a message processor that processes OTP encrypted messages that direct changes to the expansion and carry new key material to replace array elements periodically, wherein the processor or processing circuit uses the expanded entropy as a one time pad.

2. The system of claim 1 wherein the processor or processing circuit uses XOR to generate the entropy expansion.

3. The system of claim 1 wherein the processor or processing circuit uses looping to generate the entropy expansion.

4. The system of claim 1 wherein the processor or processing circuit uses SIMD to generate the entropy expansion.

5. The system of claim 1 wherein the system transmits the entropy expansion interleaved with ciphertext data.

6. The system of claim 1 wherein the system transmits the entropy expansion interleaved with ciphertext data containing token messages with the size/type information for next ciphertext data.

7. The system of claim 1 wherein the system transmits information for deriving the entropy expansion interleaved with token information.

8. The system of claim 1 wherein the system transmits information for deriving the entropy expansion interleaved with token and type information.

9. The system of claim 1 where encrypted data is transmitted on a separate data channel.

10. The system of claim 1 where one OTP channel is used to encrypt another OTP channel.

11. A secure communication system comprising:
a random number generator configured to generate a random number string;
a processor or processing circuit that expands the random number string to generate entropy expansion; and
a message processor that processes OTP encrypted messages that direct changes to the entropy expansion and continually carry new key material to replace array elements; wherein the processor or processing circuit uses the expanded entropy as a one time pad.

12. The system of claim 11 wherein the processor or processing circuit uses XOR to generate the expanded entropy.

13. The system of claim 11 wherein the processor or processing circuit uses looping to generate the expanded entropy.

14. The system of claim 11 wherein the processor or processing circuit uses SIMD to generate the expanded entropy.

15. The system of claim 11 wherein the system receives the expanded entropy interleaved with ciphertext data.

16. The system of claim 11 wherein the system receives the expanded entropy interleaved with ciphertext data to include a token message with size/type information for a next set of ciphertext data.

17. The system of claim 11 wherein the system receives the entropy expansion interleaved with token information.

18. The system of claim 11 wherein the system receives the entropy expansion interleaved with token and type information.

19. The system of claim 11 where encrypted data is transmitted on a separate data channel.

20. The system of claim 11 where one OTP channel is used to encrypt another OTP channel.
